(19) United States
(12) Patent Application Publication
(10) Pub. No.: US 2025/0283539 A1
(43) Pub. Date: Sep. 11, 2025

(54) ROTARY CONE VALVE FOR ENHANCING AERODYNAMIC STABILITY

(71) Applicant: BEIJING AEROSPACE INSTITUTE FOR METROLOGY AND MEASUREMENT TECHNOLOGY, Beijing (CN)

(72) Inventors: Shizhao LU, Beijing (CN); Fang BU, Beijing (CN); Yinxiao MIAO, Beijing (CN); Chunbo REN, Beijing (CN); Lizhen GUO, Beijing (CN); Zhaoxin SHEN, Beijing (CN); Lei GUAN, Beijing (CN)

(21) Appl. No.: 19/218,270

(22) Filed: May 24, 2025

(30) Foreign Application Priority Data
Jul. 9, 2024 (CN) 202410912141.4

(51) Int. Cl. F16K 5/02; F16K 27/06; G01N 30/20

(52) U.S. Cl. CPC F16K 5/0207; F16K 5/0271; F16K 27/062; G01N 30/20; G01N 2030/202

(57) ABSTRACT

A rotary valve for enhancing aerodynamic stability, including a stator, a rotor, a valve core, a rotating assembly and an elastic pressing assembly. An outer wall of the valve core is provided with at least two curved gas grooves uniformly distributed along a circumferential direction of the valve core. The valve core is fixed to an outer wall of the rotor. The stator is provided with a chamber in an inverted truncated-cone shape. The rotor is coaxially provided within the chamber. The stator is provided with a plurality of gas holes uniformly distributed along a circumferential direction of the stator. A diameter of the gas hole is defined as D. A distance between a first side wall and a second side wall of the gas groove is defined as L. A ratio of L to D is 0.8-1.2.

### CROSS-REFERENCE TO RELATED APPLICATIONS

This application claims the benefit of priority from Chinese Patent Application No. 202410912141.4, filed on Jul. 9, 2024. The content of the aforementioned application, including any intervening amendments made thereto, is incorporated herein by reference in its entirety.

### TECHNICAL FIELD

This application relates to rotary cone valves, and more particularly to a rotary cone valve for enhancing aerodynamic stability.

### BACKGROUND

Rotary cone valves have been widely used in a gas chromatography (GC) system (e.g., a multi-valve multi-column GC system), and is suitable for the gas flow control and other application scenarios involving gas sample injection, backflushing and switching operations. It is well known that the stability of a gas path system is critical for maintaining the instrument performance. For example, in the GC system, pressure drop and flow rate fluctuations in the gas path system will affect the baseline noise level, and the valve-switching fluctuations will also severely impact the analysis process. However, the stability of the gas path system in the existing rotary cone valves still requires improvement. Moreover, the structure of the existing rotary cone valves is not sufficiently compact.

### SUMMARY

In view of this, an object of the present disclosure is to provide a rotary cone valve for enhancing aerodynamic stability, in which the gas path cross-sectional area ratio (a ratio of a spacing between upper and lower side walls of the rotor gas groove to a diameter of a stator gas hole) and the rotor gas groove structure are optimized, thereby effectively improving the stability of the gas path system, reducing the impact of gas path pressure drop and flow rate variations on the baseline noise level, and significantly enhancing the detection performance of gas chromatography systems.

Technical solutions of the present disclosure are described as follows.

A rotary conical valve for enhancing aerodynamic stability, comprising:
a stator;
a rotor;
a valve core;
a rotating assembly; and
an elastic pressing assembly;
wherein the valve core has an inverted truncated-cone structure; an outer wall of the valve core is provided with at least two curved gas grooves uniformly distributed along a circumferential direction of the valve core; and the valve core is fixed to an outer wall of the rotor;
the stator is provided with a first chamber, and the first chamber is in an inverted truncated-cone shape; the rotor is coaxially provided within the first chamber; and the outer wall of the valve core is in contact with an inner wall of the first chamber;
the stator is provided with a plurality of gas holes uniformly distributed along a circumferential direction of the stator; and any adjacent two of the plurality of gas holes are communicated through one of the at least two curved gas grooves;
the stator is further provided with a second chamber above the first chamber; the second chamber is communicated with the first chamber; and the elastic pressing assembly is provided within the second chamber, and is configured to elastically press the rotor to achieve sealing between the outer wall of the valve core and an inner wall of the stator;
a third chamber is provided below the first chamber, and is communicated with the first chamber; the rotating assembly is provided within the third chamber, and is fixedly connected to a lower portion of the rotor; the rotating assembly is configured to drive the rotor to rotate around its own axis by a predetermined angle to perform valve switching; and
a diameter of each of the plurality of gas holes is D; each of the at least curved gas grooves has a first side wall and a second side wall parallel to the first side wall; a distance between the first side wall and the second side wall is L; and a ratio of L to D is 0.8-1.2.

In some embodiments, the ratio of L to D is 1.2;
the first side wall and the second side wall are both configured as arc-shaped flat wall surfaces;
each of the at least two curved gas grooves further has a third side wall and a fourth side wall, and the third side wall and the fourth side wall are both configured as arc-shaped curved wall surfaces; two ends of a bottom wall of each of the at least two curved gas grooves are configured as concave spherical wall surfaces; and a portion of the bottom wall between two concave spherical wall surfaces is configured as an arc-shaped concave wall surface; and
a curvature of each of the two concave spherical wall surfaces is equal to the diameter of each of the plurality of gas holes; and a central axis of each of the plurality of gas holes is configured to pass through the two concave spherical wall surfaces.

In some embodiments, the ratio of L to D is 1;
the first side wall and the second side wall are both configured as arc-shaped flat wall surfaces; a third side wall and a fourth side wall of each of the at least two gas grooves are both configured as arc-shaped curved wall surfaces; and a bottom wall of each of the at least two gas grooves is configured as an arc-shaped concave wall surface.

In some embodiments, each of the at least two curved gas grooves has a radius R of 0.4±0.05 mm and a depth H of 0.65±0.05 mm; and each of the plurality of gas holes has a diameter D of 0.75±0.05 mm and a depth of 1.85±0.05 mm.

In some embodiments, the valve core is fixed to the outer wall of the rotor by in-situ injection molding.

In some embodiments, the valve core is made of a polytetrafluoroethylene (PTFE)-polyetheretherketone (PEEK) composite material.

In some embodiments, the PTFE-PEEK composite material comprises 10-30% by weight of PTFE.

In some embodiments, the elastic pressing assembly comprises a mounting sleeve, a pressing sleeve, a pushing block, a steel ball, a spring, a gasket and a plug;
the pushing block is configured to receive a preload force applied by the elastic pressing assembly;
the mounting sleeve is threadedly connected to the stator, and is coaxial with the first chamber;
the pressing sleeve is coaxially and fixedly sleeved on the rotor; and an inner wall surface of the pressing sleeve is provided with an annular flange;
the pushing block is coaxially provided within the pressing sleeve, and is configured to be supported on a top surface of the annular flange;
the steel ball is provided at a bottom of the mounting sleeve, and is supported on the pushing block;
the spring is coaxially provided within the mounting sleeve; a bottom of the spring is configured to press against the steel ball through the gasket; and
the plug is threadedly connected to an inner cavity of the mounting sleeve; and a bottom of the plug is configured to press against a top of the spring.

In some embodiments, the rotating assembly is provided with a limiting pin;
the third chamber is provided with a limiting notch; and
the limiting pin is configured to engage with the limiting notch in response to a case that the rotating assembly rotates by the predetermined angle.

Compared to the prior art, the present disclosure has the following beneficial effects.

(1) The valve core has the overall inverted truncated-cone shape. The outer wall of the valve core has the inverted truncated-cone surface structure. The outer wall of the valve core is provided with at least two curved gas grooves uniformly distributed along the circumferential direction of the valve core. The valve core is fixed to the outer wall of the rotor. The stator is provided with the first chamber. The first chamber is in the inverted truncated-cone shape. The rotor is coaxially provided within the first chamber. The outer wall of the valve core is in contact with the inner wall of the first chamber. The stator is provided with the plurality of gas holes uniformly distributed along the circumferential direction of the stator. Any adjacent two of the plurality of gas holes are communicated through one of the at least two curved gas grooves. The stator is further provided with the second chamber above the first chamber. The second chamber is communicated with the first chamber. The elastic pressing assembly is provided within the second chamber, and is configured to elastically press the rotor to achieve sealing between the outer wall of the valve core and the inner wall of the stator. The third chamber is provided below the first chamber, and is communicated with the first chamber. The rotating assembly is provided within the third chamber, and is fixedly connected to the lower portion of the rotor. The rotating assembly is configured to drive the rotor to rotate around its own axis by a predetermined angle to perform valve switching.

By means of the above arrangement, the rotary conical valve has a compact structure. Furthermore, the diameter of each of the plurality of gas holes is D. The first side wall is parallel to the second side wall. The distance between the first side wall and the second side wall is L. The ratio of L to D is 0.8-1.2. Experimental results demonstrate that when the ratio of L to D is 0.8-1.2, the impact of variations in the gas path cross-sectional area on the carrier gas flow rate and gas path pressure drop is reduced. This design helps to prevent an increase in flow resistance and pressure loss caused by localized obstruction regions, thereby maintaining the continuity and uniformity of gas flow and reducing airflow disturbance caused by valve switching.

(2) Simulation test results demonstrate that, compared to the ratio of L to D is 1, the ratio of L to D is 1.2, and the first side wall and the second side wall are both configured as arc-shaped flat wall surfaces. The third side wall and the fourth side wall of each of the at least two curved gas grooves are both configured as arc-shaped curved wall surfaces. The two ends of the bottom wall of each of the at least two curved gas grooves are configured as concave spherical wall surfaces. A portion of the bottom wall between two concave spherical wall surfaces is configured as the arc-shaped concave wall surface. The curvature of each of the two concave spherical wall surfaces is equal to the diameter of each of the plurality of gas holes. When the central axis of each of the plurality of gas hole passes through the two concave spherical wall surfaces, a pressure difference between the gas entering and exiting the gas hole is minimized, indicating a lower pressure drop. This design challenges the traditional design approach, which suggests that to minimize the pressure drop, abrupt changes in the cross-sectional area at a connection between each of the at least two curved gas grooves and each of the plurality of gas holes should be avoided, i.e., L should not be greater than D or D should not be greater than L, and the optimal solution is to make L equal to D, that is, the ratio of L to D is 1. However, in the present disclosure, it is noted that the pressure drop of the rotary conical valve is influenced by multiple factors, including the diameter D of each of the plurality of gas holes, the distance L between the first side wall and the second side wall, and a shape of the at least two gas grooves, all these factors act in combination. Therefore, to reduce the pressure drop of the rotary conical valve, it is insufficient to exclusively targe L/D=1, as conventional designs suggest.

(3) Compared to the traditional design approach, where L/D=1 and it is believed that the bottom wall of each of the at least two curved gas grooves through which the central axis of each of the plurality of gas holes passes should be a spherical wall surface (i.e., the airflow direction is changed through the spherical wall surface). In the present disclosure, the ratio of L to D is 1. The first side wall and the second side wall are both configured as arc-shaped flat wall surfaces. The third side wall and the fourth side wall of each of the at least two gas grooves are both configured as arc-shaped curved wall surfaces. And the bottom wall of each of the at least two gas grooves is configured as the arc-shaped concave wall surface, i.e., the bottom wall of each of the at least two gas grooves is configured as a single continuous arc-shaped concave wall surface, rather than being composed of three segments (i.e., two ends of the bottom wall of of each of the at least two curved gas grooves are configured as concave spherical wall surfaces, and the portion of the bottom wall between two concave spherical wall surfaces is configured as an arc-shaped concave wall surface). Simulation experiments have demonstrated that the rotary cone valve provided herein has a smaller pressure drop.

(4) Each of the at least two curved gas grooves has the radius R of 0.4±0.05 mm and the depth H of 0.65±0.05 mm. Each of the plurality of gas holes has the diameter D of 0.75±0.05 mm and the depth of 1.85±0.05 mm, which enables precise regulation of gas flow in multi-valve multi-column gas chromatography system.

(5) The valve core is fixed to the outer wall of the rotor by in-situ injection molding, which enhances the bonding strength between the valve core and the rotor, reduces assembly errors, and improves the sealing performance between the outer wall of the valve core and the inner wall of the stator.

(6) The valve core is made of the PTFE-PEEK composite material, which provides both a low friction coefficient and excellent wear resistance.

(7) Polytetrafluoroethylene (PTFE), as an excellent self-lubricating material, has been widely used in mechanical engineering due to its extremely low friction coefficient and outstanding chemical stability. It is commonly employed in applications requiring wear resistance and lubrication. The wear resistance of PTFE is attributed to its low friction coefficient and self-lubricating properties. However, as a sealing material, PTFE has inherent limitations, including low load-bearing capacity, susceptibility to creep and poor thermal conductivity. To overcome these drawbacks, the simplest and most effective approach is filler modification, which enhances the hardness, strength and toughness of PTFE, thereby improving its wear resistance. Commonly used fillers include carbon fiber, glass fiber, molybdenum disulfide, graphite, nanoparticles and metal oxides. However, inorganic fillers often exhibit poor compatibility with PTFE, leading to significant interfacial separation and a high friction coefficient. In conventional solutions, polyetheretherketone (PEEK) is often used as a reinforcing filler due to its high mechanical strength, superior wear resistance, and excellent compatibility with PTFE. In such cases, a weight percentage concentration of PEEK is lower than that of PTFE. However, these studies are limited to modifying PTFE with PEEK. In the present disclosure, the valve core provided herein uses the PTFE-PEEK composite material containing 10-30% by weight of PTFE, i.e., PTFE is used as a filler for PEEK. Since PEEK itself has high mechanical strength and wear resistance, using PEEK as the base material and PTFE as the filler enhances the wear resistance of the valve core, reduces the friction coefficient and improves lubrication performance.

### BRIEF DESCRIPTION OF THE DRAWINGS

FIG. 1 is a perspective view of a rotary cone valve for enhancing aerodynamic stability provided in Example 1 of the present disclosure;

FIG. 2 is a front view of the rotary cone valve provided in Example 1 of the present disclosure;

FIG. 3 is a cross-sectional view of the rotary cone valve along an A-A line in FIG. 2;

FIG. 4 is a structural diagram of the rotary cone valve provided in Example 1 of the present disclosure;

FIG. 5 is a cross-sectional view of the rotary cone valve along a B-B line in FIG. 4;

FIG. 6 is a structural diagram of a rotor in FIG. 3;

FIG. 7 is a structural diagram of a valve core in FIG. 3;

FIG. 8A is a geometric model diagram of L/D=0.8 provided in Example 2 of the present disclosure;

FIG. 8B is a velocity vector diagram of L/D=0.8 provided in Example 2 of the present disclosure;

FIG. 8C is a velocity contour diagram of L/D=0.8 provided in Example 2 of the present disclosure; and

FIG. 8D is a pressure contour diagram of L/D=0.8 provided in Example 2 of the present disclosure;

FIG. 9A is a geometric model diagram of L/D=1 provided in Example 2 of the present disclosure;

FIG. 9B is a velocity vector diagram of L/D=1 provided in Example 2 of the present disclosure;

FIG. 9C is a velocity contour diagram of L/D=1 provided in Example 2 of the present disclosure; and

FIG. 9D is a pressure contour diagram of L/D=1 provided in Example 2 of the present disclosure;

FIG. 10A is a geometric model diagram of L/D=1.2 provided in Example 2 of the present disclosure;

FIG. 10B is a velocity vector diagram of L/D=1.2 provided in Example 2 of the present disclosure;

FIG. 10C is a velocity contour diagram of L/D=1.2 provided in Example 2 of the present disclosure; and

FIG. 10D is a pressure contour diagram of L/D=1.2 provided in Example 2 of the present disclosure; and

FIG. 11A is a geometric model diagram of L/D=1 provided in Example 3 of the present disclosure;

FIG. 11B is a velocity vector diagram of L/D=1 provided in Example 3 of the present disclosure;

FIG. 11C is a velocity contour diagram of L/D=1 provided in Example 3 of the present disclosure; and

FIG. 11D is a pressure contour diagram of L/D=1 provided in Example 3 of the present disclosure.

In the figures: 1—plug; 2—spring; 3—gasket; 4—steel ball; 5—rotor; 501—pressing sleeve mounting portion; 502—valve core mounting portion; 503—positioning flange; 504—rotation fixing portion; 6—valve core; 601—valve core inner cavity; 7—rotating assembly; 8—gas groove; 801—end bottom wall; 802—middle section bottom wall; 803—first side wall; 804—second side wall; 805—third side wall; 806—fourth side wall; 9—stator; 901—gas hole; 101—first air tube fitting section; 102—second air tube fitting section; 103—third air tube fitting section; 11—pressing sleeve; 12—pushing block; and 13—mounting sleeve.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

### Example 1

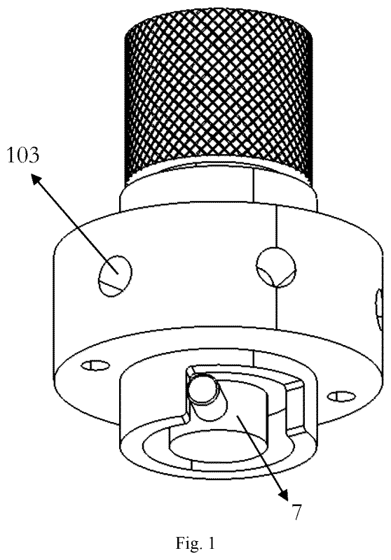

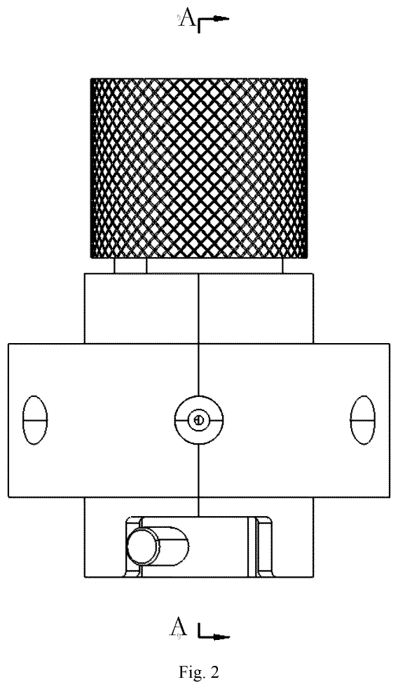

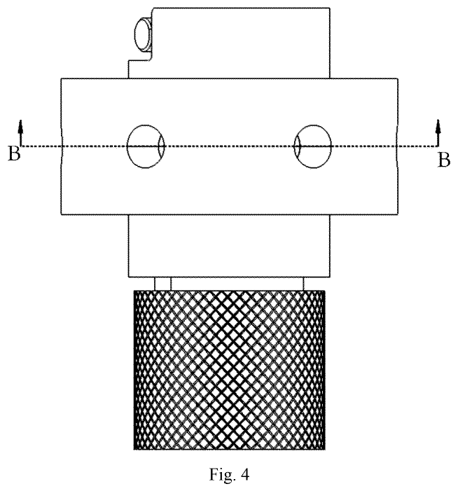

As shown in FIGS. 1-7, an embodiment of the present disclosure provides a rotary cone valve for enhancing aerodynamic stability, including a stator 9, a rotor 5, a valve core 6, a rotating assembly 7 and an elastic pressing assembly.

The valve core 6 has an overall inverted truncated-cone shape. An outer wall of the valve core 6 has an inverted truncated-cone surface structure. The outer wall of the valve core 6 is provided with at least two curved gas grooves 8 uniformly distributed along a circumferential direction of the valve core 6. The valve core 6 is fixed to an outer wall of the rotor 5. The stator 9 is provided with a first chamber. The first chamber is in an inverted truncated-cone shape. The rotor 5 is coaxially provided within the first chamber. The outer wall of the valve core 6 is in contact with an inner wall of the first chamber. The stator 9 is provided with a plurality of gas holes 901 uniformly distributed along a circumferential direction of the stator 9. Any adjacent two of the plurality of gas holes 901 are communicated through one of the at least two curved gas grooves 8. The stator 9 is further provided with a second chamber above the first chamber. The second chamber is communicated with the first chamber. The elastic pressing assembly is provided within the second chamber, and is configured to elastically press the rotor 5 to achieve sealing between the outer wall of the valve core 6 and an inner wall of the stator 9. A third chamber is provided below the first chamber, and is communicated with the first chamber. The rotating assembly 7 is provided within the third chamber, and is fixedly connected to a lower portion of the rotor 5. The rotating assembly 7 is configured to drive the rotor 5 to rotate around its own axis by a predetermined angle to perform valve switching. A diameter of each of the plurality of gas holes 901 is D. Each of the at least curved gas grooves 8 has a first side wall 803 and a second side wall 804 parallel to the first side wall 803. A distance between the first side wall 803 and the second side wall 804 is L. And a ratio of L to D is 0.8-1.2. The gas flows through the two gas paths formed by the plurality of gas holes 901 and the at least two curved gas grooves 8, where the ratio of L to D can be considered as a ratio of cross-sectional areas of these two gas paths.

By means of the above arrangement, the rotary cone valve has a compact structure. Furthermore, the diameter of each of the plurality of the gas holes 901 is D. The distance between the first side wall 803 and the second side wall 804 is L. The ratio of L to D is 0.8-1.2. Experimental results demonstrate that when the ratio of L to D is 0.8-1.2, the impact of variations in the gas path cross-sectional area on the carrier gas flow rate and gas path pressure drop is reduced. This design helps to prevent an increase in flow resistance and pressure loss caused by localized obstruction regions, thereby maintaining the continuity and uniformity of gas flow and reducing airflow disturbance caused by valve switching.

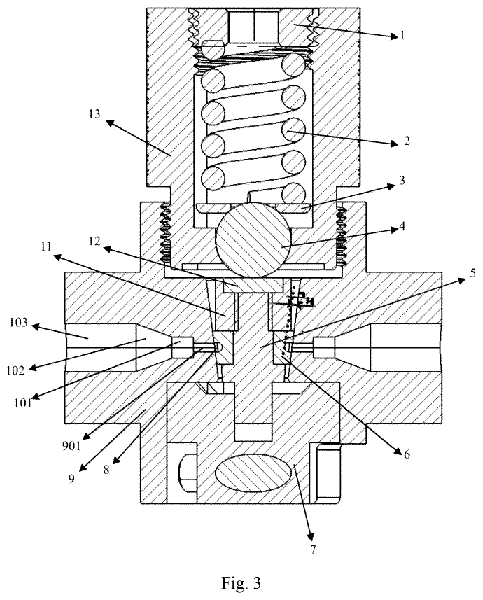

Specifically, in this embodiment, as shown in FIG. 3, the elastic pressing assembly includes a mounting sleeve 13, a pressing sleeve 11, a pushing block 12, a steel ball 4, a spring 2, a gasket 3 and a plug 1. The pushing block 12 is configured to receive a preload force applied by the elastic pressing assembly. The mounting sleeve 13 is threadedly connected to the stator 9, and is coaxial with the first chamber. The pressing sleeve 11 is coaxially and fixedly sleeved on the rotor 5. An inner wall surface of the pressing sleeve 11 is provided with an annular flange. The pushing block 12 is coaxially provided within the pressing sleeve 11, and is configured to be supported on a top surface of the annular flange. The steel ball 4 is provided at a bottom of the mounting sleeve 13, and is supported on the pushing block 12. The spring 2 is coaxially provided within the mounting sleeve 13. A bottom of the spring 2 is configured to press against the steel ball 4 through the gasket 3. The plug 1 is threadedly connected to an inner cavity of the mounting sleeve 13. A bottom of the plug 1 is configured to press against a top of the spring 2. The elastic pressing assembly has a simple and compact structure and can be easily disassembled.

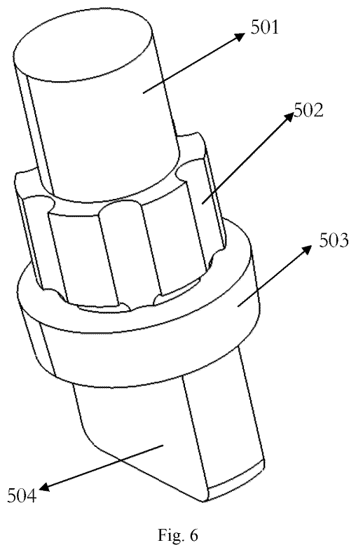

Specifically, in this embodiment, as shown in FIGS. 1-3, the rotating assembly 7 is provided with a limiting pin, which is cylindrical. The third chamber is provided with a limiting notch. The limiting pin is configured to engage with the limiting notch in response to a case that the rotating assembly rotates by a predetermined angle, thereby preventing excessive rotation. As shown in FIG. 6, the rotor 5 is sequentially provided with a pressing sleeve mounting portion 501, a valve core mounting portion 502, a positioning flange 503 and a rotation fixing portion 504 from top to bottom. The pressing sleeve 11 is coaxially and fixedly (e.g., by threaded connection or interference fit) sleeved on the pressing sleeve mounting portion 501. The rotating assembly 7 is fixedly mounted to the rotation fixing portion 504. The valve core 6 is fixed to the valve core mounting portion 502 by in-situ injection molding. Specifically, the valve core 6 includes a valve core inner cavity 601, and the valve core inner cavity 601 is tightly secured to the valve core mounting portion 502. A bottom surface of the valve core 6 is in contact with a top surface of the positioning flange 503.

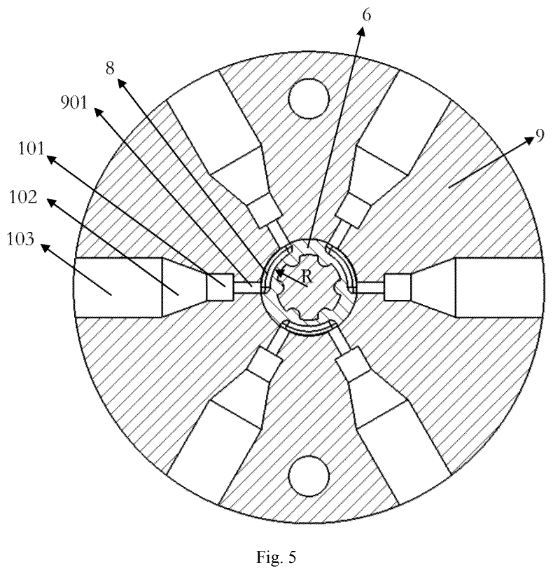

As shown in FIG. 5, through holes connected to each of the plurality of gas holes 901 from the inside to the outside sequentially includes a first air tube fitting section 101, a second air tube fitting section 102 and a third air tube fitting section 103. During installation of an air tube, the air tube is inserted into the first air tube fitting section 101, the second air tube fitting section 102 and the third air tube fitting section 103. An outer wall of the air tube is in contact with inner walls of the first air tube fitting section 101, the second air tube fitting section 102 and the third air tube fitting section 103. For an air-inlet tube, gas in the air-inlet tube flows through each of the plurality of gas holes 901 into the gas groove 8. For an air-outlet tube, gas in the gas groove 8 flows through each of the plurality of gas holes 901 into the air-outlet tube.

In this embodiment, the number of the plurality of gas holes 901 is six. The number of the at least two curved gas grooves 8 is three. Three curved gas grooves 8 are arranged at 120° intervals, and six gas holes 901 are arranged at 60° intervals. Once the rotating assembly 7 is connected to an aerodynamic component, the rotating assembly 7 drives the rotor 5 to rotate by 60° in a forward or reverse direction, thereby enabling valve switching and gas path transition.

More specifically, in this embodiment, the valve core 6 is fixed to the outer wall of the rotor 5 by in-situ injection molding, which enhances the bonding strength between the valve core 6 and the rotor 5, reduces assembly errors and improves the sealing performance between the outer wall of the valve core 6 and the inner wall of the stator 9. Furthermore, the valve core 6 is made of a polytetrafluoroethylene (PTFE)-polyetheretherketone (PEEK) composite material, which provides the valve core 6 with both a low friction coefficient and excellent wear resistance.

More specifically, in this embodiment, the PTFE-PEEK composite material includes 10-30% by weight of PTFE. PTFE, as an excellent self-lubricating material, has been widely used in mechanical engineering due to its extremely low friction coefficient and outstanding chemical stability. It is commonly employed in applications requiring wear resistance and lubrication. The wear resistance of PTFE is attributed to its low friction coefficient and self-lubricating properties. However, as a sealing material, PTFE has inherent limitations, including low load-bearing capacity, susceptibility to creep and poor thermal conductivity. To overcome these drawbacks, the simplest and most effective approach is filler modification, which enhances the hardness, strength and toughness of PTFE, thereby improving its wear resistance. Commonly used fillers include carbon fiber, glass fiber, molybdenum disulfide, graphite, nanoparticles and metal oxides. However, inorganic fillers often exhibit poor compatibility with PTFE, leading to significant interfacial separation and a high friction coefficient. In conventional solutions, polyetheretherketone (PEEK) is often used as a reinforcing filler due to its high mechanical strength, superior wear resistance, and excellent compatibility with PTFE. In such cases, the mass fraction of PEEK is lower than that of PTFE. However, these studies are limited to modifying PTFE with PEEK.

In the present disclosure, the valve core 6 uses the PTFE-PEEK composite material containing 10-30% by weight of PTFE, i.e., PTFE is used as a filler for PEEK. Since PEEK itself has high mechanical strength and wear resistance, using PEEK as the base material and PTFE as the filler enhances the wear resistance of the valve core 6, reduces the friction coefficient, and improves lubrication performance.

More specifically, in this embodiment, each of the three curved gas grooves 8 has a radius R of 0.4±0.05 mm and a depth H of 0.65±0.05 mm. Each of the six gas holes 901 has a diameter D of 0.75±0.05 mm and a depth of 1.85±0.05 mm. Additionally, a conical surface angle of the valve core 6 can be designed to be 10-15°. In this embodiment, the conical surface angle of the valve core 6 is 14°.

### Example 2

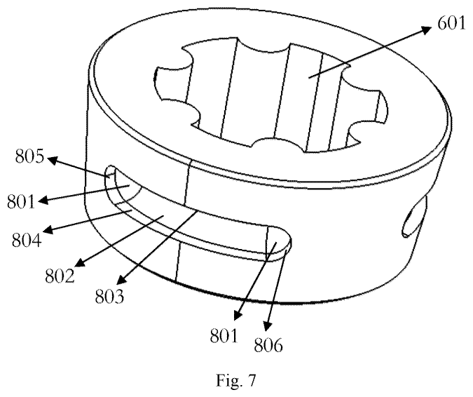

Based on Example 1 and with reference to FIG. 7, the first side wall 803 and the second side wall 804 of the at least two curved gas grooves 8 are both configured as arc-shaped flat wall surfaces, while a third side wall 805 and a fourth side wall 806 of the at least two curved gas grooves 8 are both configured as arc-shaped curved wall surfaces. Two ends of a bottom wall of each of the at least two curved gas grooves 8 are configured as concave spherical wall surfaces (i.e., an end bottom wall 801 is configured as a concave spherical wall surface, and in this embodiment, the end bottom wall 801 is configured as a quarter-sphere wall surface). A portion of the bottom wall between two concave spherical wall surfaces is configured as an arc-shaped concave wall surface (i.e., a middle section bottom wall 802 is configured as an arc-shaped concave wall surface). A curvature of each of the two concave spherical wall surfaces is equal to a diameter of each of the plurality of gas holes 901. And a central axis of each of the plurality of gas holes 901 is configured to pass through the two concave spherical wall surfaces.

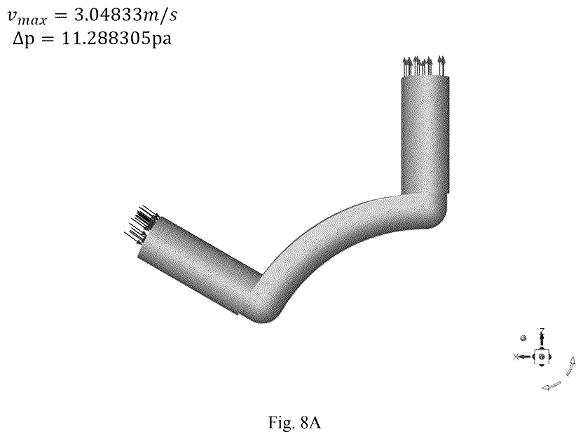

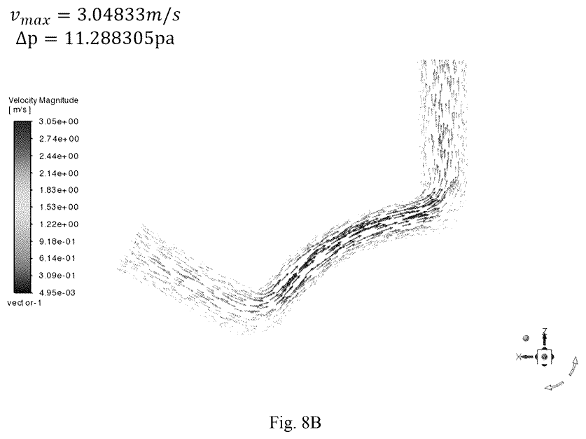

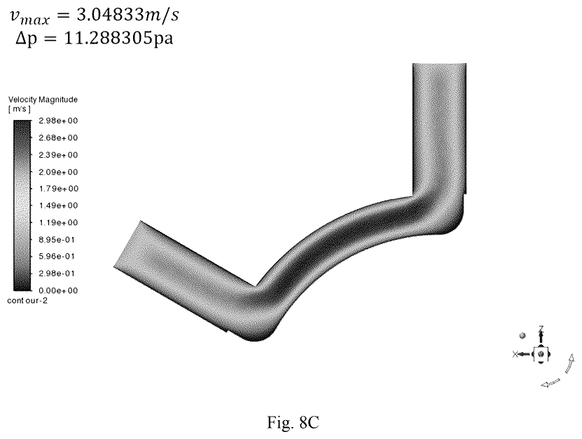

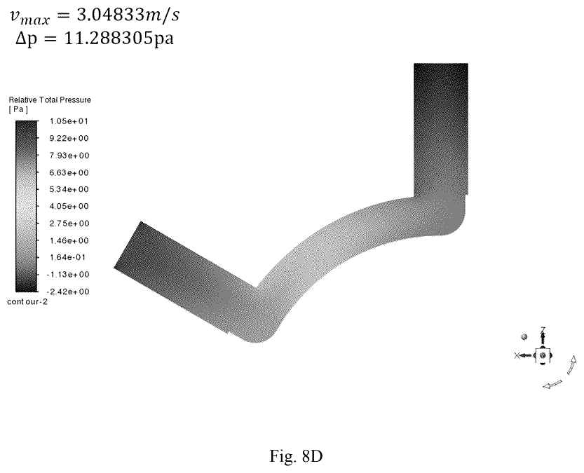

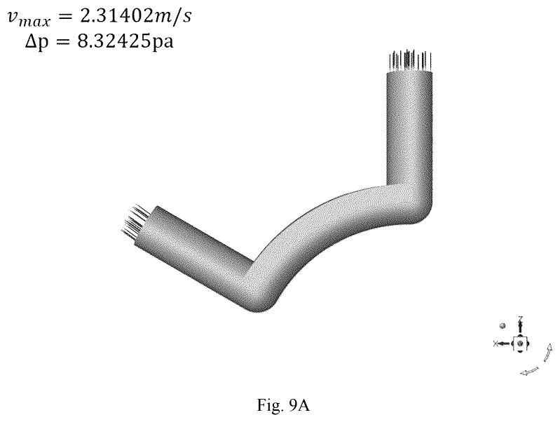

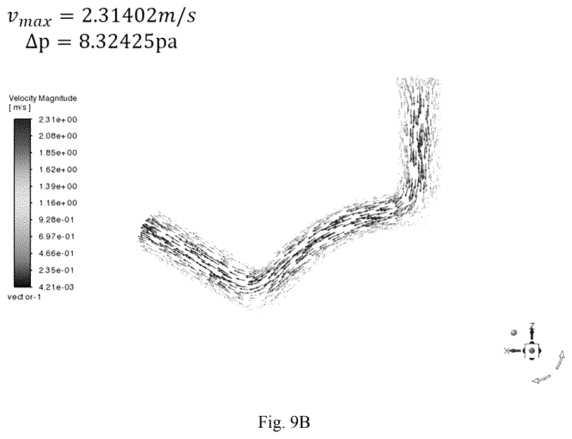

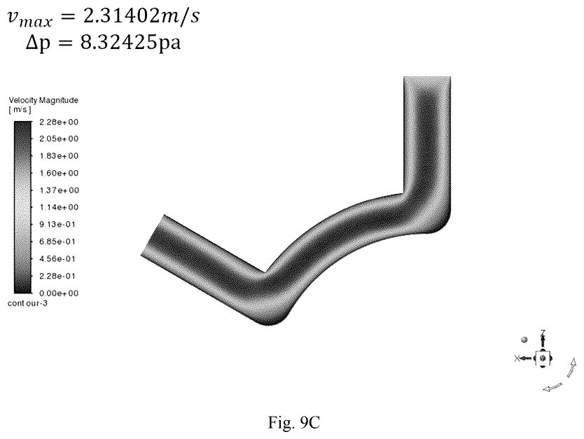

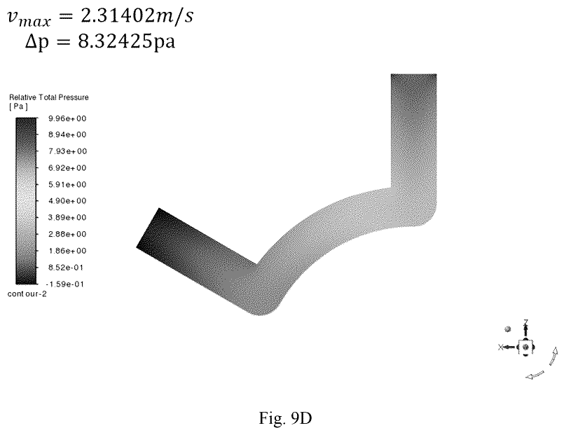

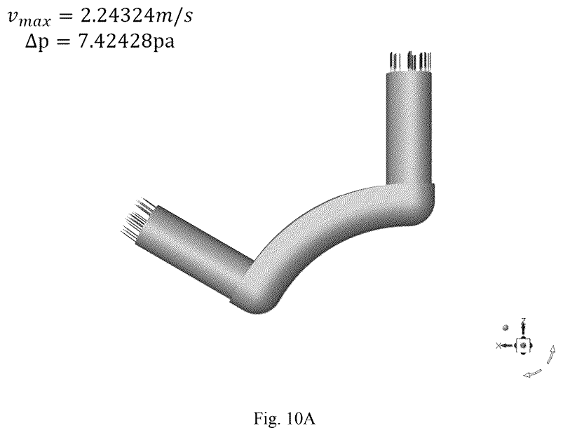

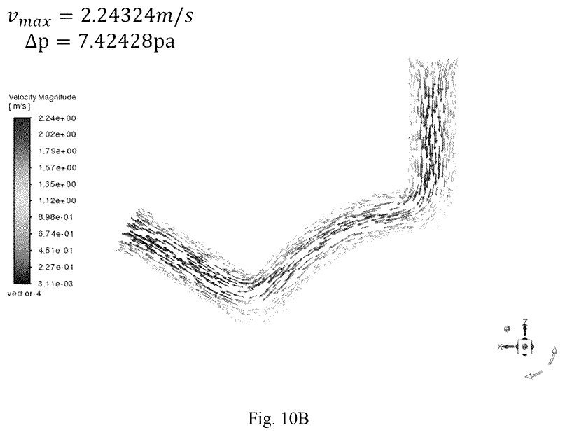

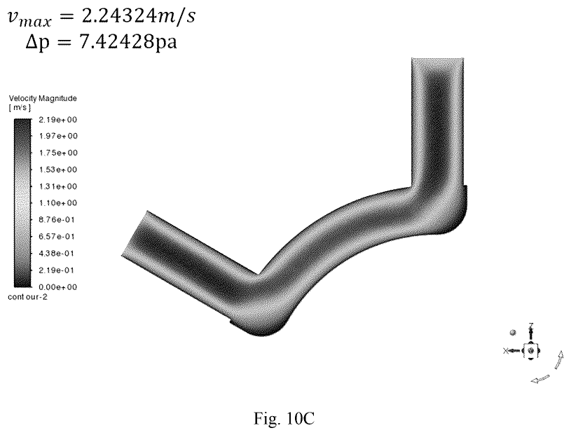

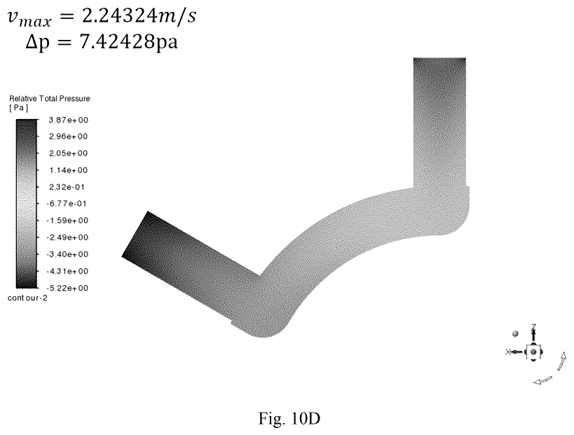

Under operating conditions of 0.3 MPa and 35° C., helium is used as a working gas and the only variable changed is the ratio of L to D. As shown in FIGS. 8A-8D, when a ratio of L to D is 0.8, computational fluid dynamics (CFD) simulation results using Ansys Fluent indicate a pressure drop of 11.288305 Pa. As shown in FIGS. 9A-9D, when the ratio of L to D is 1, CFD simulation results using Ansys Fluent indicate a pressure drop of 8.32425 Pa. As shown in FIGS. 10A-10D, when the ratio of L to D is 1.2, CFD simulations results using Ansys Fluent indicate a pressure drop of 7.42428 Pa.

It can be seen that, compared to the ratio of L to D being 1, the present embodiment with the ratio of L to D of 1.2 results in a smaller pressure drop, which challenges the traditional design approach. The traditional design approach suggests that to minimize the pressure drop, abrupt changes in the cross-sectional area at a connection between each of the at least two curved gas grooves 8 and each of the plurality of gas holes 901 should be avoided, i.e., L should not be greater than D or D should not be greater than L, and the optimal solution is to make L equal to D, i.e., L/D=1. However, in the present disclosure, it is noted that the pressure drop of the rotary cone valve is influenced by multiple factors, including the diameter D of each of the plurality of gas hole 901, the distance L between the first side wall 803 and the second side wall 804 and a shape of the at least two gas grooves 8, all these factors act in combination. To reduce the pressure drop of the rotary cone valve, the design should not simply follow the traditional approach of aiming for L/D=1. The structure of the gas groove 8 and L/D=1.2 designed herein can enhance the stability of the gas path system.

### Example 3

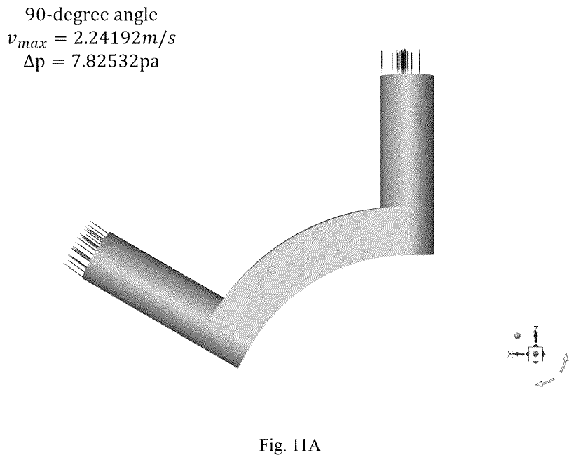

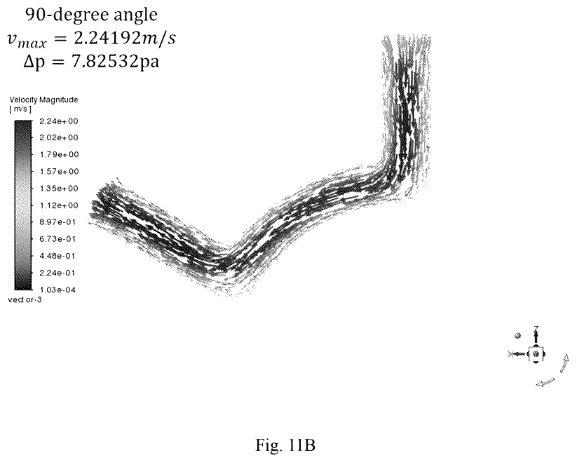

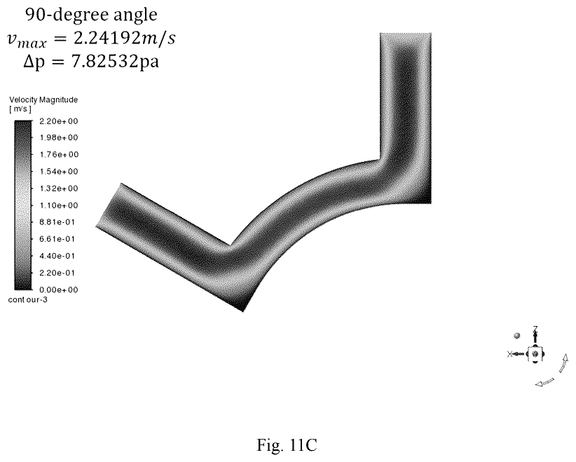

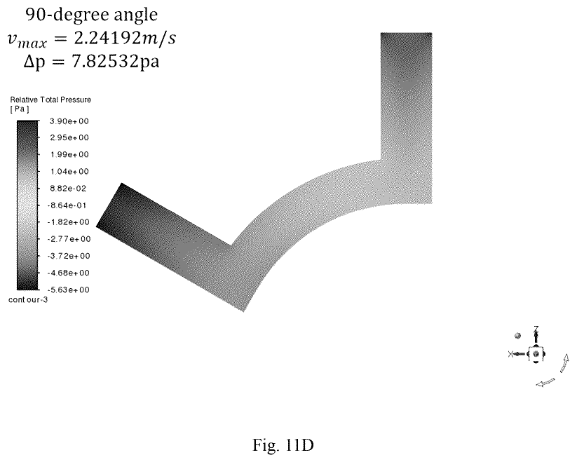

Based on Example 1, referring to FIG. 7, the first side wall 803 and the second side wall 804 of the at least two curved gas grooves 8 are both configured as arc-shaped flat wall surfaces, while a third side wall 805 and a fourth side wall 806 of the at least two curved gas grooves 8 are both configured as arc-shaped curved wall surfaces. A bottom wall of each of the at least two gas grooves 8 is configured as an arc-shaped concave wall surface. A ratio of L to D is 1. Unlike the case of L/D=1 in Example 2, in this embodiment, the bottom wall of each of the at least two gas grooves 8 is configured as the arc-shaped concave wall surface, i.e., the bottom wall of each of the at least two gas grooves 8 is a single continuous arc-shaped concave wall surface, rather than being composed of three segments (i.e., two ends of a bottom wall of the at least two curved gas grooves are configured as concave spherical wall surfaces, and a portion of the bottom wall between two concave spherical wall surfaces is configured as an arc-shaped concave wall surface). Under operating conditions of 0.3 MPa and 35° C., with helium as a working gas, computational fluid dynamics (CFD) simulation results using Ansys Fluent have verified that, as shown in FIGS. 11A-11D, a pressure drop in this case is 7.82532 Pa. In contrast, when L/D=1 in Example 2, the pressure drop is 8.32425 Pa. Therefore, the rotary cone valve provided herein exhibits a lower pressure drop.

It can be seen that, compared to the traditional design approach where L/D=1 and the bottom wall of each of the at least two curved gas groove 8 through which the central axis of each of the plurality of gas holes 901 passes should be a spherical wall surface (i.e., the airflow direction is changed through the spherical wall surface to achieve a smaller pressure drop). In this embodiment, with L/D=1, the bottom wall of each of the at least two gas grooves 8 is an arc-shaped concave wall surface, i.e., the bottom wall of each of the at least two gas grooves 8 is a single continuous arc-shaped concave wall surface, rather than being composed of three segments, resulting in a smaller pressure drop.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A rotary conical valve for enhancing aerodynamic stability, comprising:
a stator;
a rotor;
a valve core;
a rotating assembly; and
an elastic pressing assembly;
wherein the valve core has an inverted truncated-cone structure; an outer wall of the valve core is provided with at least two curved gas grooves uniformly distributed along a circumferential direction of the valve core; and the valve core is fixed to an outer wall of the rotor;
the stator is provided with a first chamber, and the first chamber is in an inverted truncated-cone shape; the rotor is coaxially provided within the first chamber; and the outer wall of the valve core is in contact with an inner wall of the first chamber;
the stator is provided with a plurality of gas holes uniformly distributed along a circumferential direction of the stator; and any adjacent two of the plurality of gas holes are communicated through one of the at least two curved gas grooves;
the stator is further provided with a second chamber above the first chamber; the second chamber is communicated with the first chamber; and the elastic pressing assembly is provided within the first chamber, and is configured to elastically press the rotor to achieve sealing between the outer wall of the valve core and an inner wall of the stator;
a third chamber is provided below the first chamber, and is communicated with the first chamber; the rotating assembly is provided within the third chamber, and is fixedly connected to a lower portion of the rotor; the rotating assembly is configured to drive the rotor to rotate around its own axis by a predetermined angle to perform valve switching; and
a diameter of each of the plurality of gas holes is D; each of the at least curved gas grooves has a first side wall and a second side wall parallel to the first side wall; a distance between the first side wall and the second side wall is L; and a ratio of L to D is 0.8-1.2.

2. The rotary cone valve of claim 1, wherein the ratio of L to D is 1.2;
the first side wall and the second side wall are both configured as arc-shaped flat wall surfaces;
each of the at least two curved gas grooves further has a third side wall and a fourth side wall, and the third side wall and the fourth side wall are both configured as arc-shaped curved wall surfaces; two ends of a bottom wall of each of the at least two curved gas grooves are configured as concave spherical wall surfaces; and a portion of the bottom wall between two concave spherical wall surfaces is configured as an arc-shaped concave wall surface; and
a curvature of each of the two concave spherical wall surfaces is equal to the diameter of each of the plurality of gas holes; and a central axis of each of the plurality of gas holes is configured to pass through the two concave spherical wall surfaces.

3. The rotary cone valve of claim 1, wherein the ratio of L to D is 1;
the first side wall and the second side wall are both configured as arc-shaped flat wall surfaces; a third side wall and a fourth side wall of each of the at least two gas grooves are both configured as arc-shaped curved wall surfaces; and a bottom wall of each of the at least two gas grooves is configured as an arc-shaped concave wall surface.

4. The rotary cone valve of claim 1, wherein each of the at least two curved gas grooves has a radius R of 0.4±0.05 mm and a depth H of 0.65±0.05 mm; and each of the plurality of gas holes has a diameter D of 0.75±0.05 mm and a depth of 1.85±0.05 mm.

5. The rotary cone valve of claim 1, wherein the valve core is fixed to the outer wall of the rotor by in-situ injection molding.

6. The rotary cone valve of claim 5, wherein the valve core is made of a polytetrafluoroethylene (PTFE)-polyetheretherketone (PEEK) composite material.

7. The rotary cone valve of claim 6, wherein the PTFE-PEEK composite material comprises 10-30% by weight of PTFE.

8. The rotary cone valve of claim 1, wherein the elastic pressing assembly comprises a mounting sleeve, a pressing sleeve, a pushing block, a steel ball, a spring, a gasket and a plug;
the pushing block is configured to receive a preload force applied by the elastic pressing assembly;
the mounting sleeve is threadedly connected to the stator, and is coaxial with the first chamber;
the pressing sleeve is coaxially and fixedly sleeved on the rotor; and an inner wall surface of the pressing sleeve is provided with an annular flange;
the pushing block is coaxially provided within the pressing sleeve, and is configured to be supported on a top surface of the annular flange;
the steel ball is provided at a bottom of the mounting sleeve, and is supported on the pushing block;
the spring is coaxially provided within the mounting sleeve; a bottom of the spring is configured to press against the steel ball through the gasket; and
the plug is threadedly connected to an inner cavity of the mounting sleeve; and a bottom of the plug is configured to press against a top of the spring.

9. The rotary cone valve of claim 1, wherein the rotating assembly is provided with a limiting pin;
the third chamber is provided with a limiting notch; and
the limiting pin is configured to engage with the limiting notch in response to a case that the rotating assembly rotates by the predetermined angle.
